(19) United States
(12) Patent Application Publication
(10) Pub. No.: US 2014/0279013 A1
(43) Pub. Date: Sep. 18, 2014

(54) ONLINE AND OFFLINE ECOMMERCE CONNECTIONS

(71) Applicants: Yan Chelly, Raanana (IL); Oded Shtitzki Levi, Tel Aviv (IL); Tomer Dekel, Natanya (IL); Amit Reuven Menipaz, Los Gatos, CA (US)

(72) Inventors: Yan Chelly, Raanana (IL); Oded Shtitzki Levi, Tel Aviv (IL); Tomer Dekel, Natanya (IL); Amit Reuven Menipaz, Los Gatos, CA (US)

(73) Assignee: eBay Inc., San Jose, CA (US)

(21) Appl. No.: 13/868,597

(22) Filed: Apr. 23, 2013

Related U.S. Application Data
(60) Provisional application No. 61/779,789, filed on Mar. 13, 2013.

(51) Int. Cl. G06Q 30/02

(52) U.S. Cl. CPC G06Q 30/0269
USPC 705/14.58

(57) ABSTRACT

Product information from local searches can be furnished based on user actions with respect to an eCommerce system. Information about user actions with respect to a product on the eCommerce system can be retrieved from the eCommerce system. A user intent to purchase the product may be determined based on the information about user actions. The product may then be matched to a product on a local search service. A local search on the matched product may then be performed on the local service, to locate one or more stores local to a user's current location that have the matched product in stock. The results from the local search may be displayed to a user.

### RELATED APPLICATIONS

This application claims the benefit of U.S. Provisional Application No. 61/779,789, filed Mar. 13, 2013, which application is incorporated by reference herein.

### TECHNICAL FIELD

This application relates generally to eCommerce sessions. More particularly, this application relates to offers or products from an eCommerce service that are provided based on user location.

### BACKGROUND

The ever increasing use of smart phones, such as the iPhone (from Apple, Inc. of Cupertino Calif.), with data connections and location determination capabilities is slowly changing the way people shop for products and services. Smart phones can provide users with nearly instant information for price comparison purposes. For example, applications such as RedLaser™ (from eBay, Inc. of San Jose, Calif.) allow a smart phone user to scan a bar code and instantly check prices across online and local retail outlets. Smart phones also commonly include mechanisms, such as global positioning satellite (GPS) receivers, that allow the devices to constantly update location information.

### BRIEF DESCRIPTION OF DRAWINGS

FIG. 1 is a network diagram depicting a client-server system, within which one example embodiment may be deployed.

FIG. 2 is a block diagram illustrating marketplace and payment applications that, in one example embodiment, are provided as part of the networked system of FIG. 1.

FIG. 3 is a diagram illustrating a system in accordance with an example embodiment.

FIG. 4 is a flow diagram illustrating a method, in accordance with an example embodiment, of obtaining local and eCommerce product listings based on user intent.

FIG. 5 depicts a method, in accordance with an example embodiment, of presenting local and online product results.

FIG. 6 is a screen capture depicting a method, in accordance with an example embodiment, of displaying an alert notification.

FIG. 7 is a screen capture depicting a method, in accordance with an example embodiment, of displaying a map screen.

FIG. 8 is a screen capture depicting a method, in accordance with an example embodiment, of displaying a coupon screen.

FIG. 9 is a flow diagram illustrating a method, in accordance with an example embodiment suitable for mapping unstructured documents to structured documents.

FIG. 10 is a diagram illustrating a comparison of documents in accordance with an example embodiment.

FIG. 11 is a flow diagram illustrating a method, in accordance with an example embodiment, of displaying product information to a user.

FIG. 12 is a block diagram of a machine in the form of a computer system within which a set of instructions may be executed for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The line between online shopping (e.g., using a computer or smartphone to make a purchase over a network) and offline shopping (e.g., purchasing at a physical store) is blurring. Today, people no longer see a distinction between the two. 80% of shoppers research online before making a purchase, and they may switch devices to suit their needs. 51% of shoppers research online and then visit a physical store to purchase. 17% of shoppers visit a store first and then purchase online later. Another 32% will research online, visit a store to view a product in person, and then return online to purchase.

In an example embodiment, an application provides a new buying experience that breaks the boundaries between online and offline shopping. This may be accomplished by, for example, leveraging online user behavior from an eCommerce system, a local shopping application, and mobile scannable coupons.

Discussed in this document is an eCommerce system. Such an ecommerce system provides items for sale to users over the Internet, from remote sellers. One example of an eCommerce system is an item listing system such as eBay™. An eCommerce system may be accessed using a web browser on a traditional computer or smartphone, via a direct application, or even through a third-party application via an Application Program Interface (API).

Also discussed in this document is a local search system. Such a local search system provides for searches for items available in a particular location, such as items within a certain radius of a user's current location. One example of a local search system is Milo™. A local search system may be accessed using a web browser on a traditional computer or smartphone, via a direct application, or even through a third-party application via an API.

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective devices 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114, The programmatic client 108 may, for example, be a seller application (e.g., the TurboLister application developed by eBay of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114, For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

FIG. 2 is a block diagram illustrating marketplace and payment applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214, For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make listings available via the networked system 102 as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102 (such as, for example, messages advising users regarding the status of listings at the networked system 102 (e.g., providing “outbid” notices to bidders during an auction process or to provide promotional and merchandising information to users)). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

FIG. 3 is a diagram illustrating a system 300 in accordance with an example embodiment. Included in the system 300 is a user intent module 302. The user intent module 302 includes a mechanism to determine user intent. This may include accessing and utilizing a formula or formulas that allow the system 300 to determine with high accuracy user buying intent for very specific products, leveraging eCommerce system and local search system catalog data, as well as eCommerce online user behavioral data. The user intent module 302 leverages the user behavioral data with zero effort from the user side. Structured catalog information is utilized to ensure an accurate match between the user behavioral intent and a specific product.

User events matched to specific products may be stored for access by the user intent module 302. These user events may include, for example, unsuccessful bids, watched items, item views, and search results. All of this can be used as input to a formula to derive specific products that the user may have an interest in purchasing. For example, the more often the user has searched for a particular product within a period of time, the higher the user intention score for that particular product during for that period of time.

An alerts notification module 304 may notify a user based on geolocation and potential offline retail stores holding a specified product in stock. The alerts notification module 304 can leverage store open hours data as well as user movement information to determine which products to notify the user about.

A map module 306 may maintain a list of stores holding the specific product in stock, along with price for the specific product and a location of the store.

A wish list management module 308 allows users to manage the products that they explored online, providing the capability to remove non-relevant products (e.g., already bought, not interested anymore).

A login module 310 manages a user's account and permits the user to log into the account using credentials, such as a user name and password.

A geolocation module 312 maintains current information about the user's location. This may include, for example, accessing a global positioning system ((GPS) hardware device for information that can be translated into a location of the user.

A local search interface 314 interfaces with a local search system, such as Milo™, to perform various searches and matches, as will be described in more detail below.

A display module 316 displays result information to a user.

FIG. 4 is a flow diagram illustrating a method 400, in accordance with an example embodiment, of obtaining local and eCommerce product listings based on user intent. At operation 402, a time interval may be defined, This may be defined by, for example, a site administrator. An eCommerce System database 404 may be accessed at the appropriate time intervals to extract various information about users. For each user of interest, the system may extract bids 406a the user has made on products, watches 406b the user has initiated on products, views 406c the user made on products, and search result pages 406d. A watch is an action by a user to follow a product without actually bidding (e.g., receiving updates, or merely having the product stored in a “watch list”). A view is any action by the user to view the product. As can be seen, each of these items 406a, 406b, 406c, 406d relate to products, and as such may be stored on a per-product bases. For any corresponding item, at operation 408 it may be determined if the user actually purchased the item. If so, then the system may assume the user has no need to purchase the item again, and thus at operation 410 may delete the corresponding data (e.g., bids, watches, views, search result pages) related to the item.

If the user has not purchased the corresponding item, then at operation 412 the system can score a user intention to purchase on a per product basis. This user intention may be stored in an intention database 414 by calling a local search system API, This process may be iterated for each product the system has data on for the user, which the user has not purchased yet.

At operation 416, eCommerce system products that have high user intent to purchase may be matched to local search system products. This may be performed by using various tools to map products in the eCommerce system 426 to the same products in the local search system 428. This will be described in more detail later. Once this matching has occurred, then at operation 418 store locations and inventory levels for the matched products in local stores can be obtained by accessing a local search system API, This information may be stored in a physical inventory database 420. Likewise, eCommerce deals from the eCommerce system 426 thr the matched products may also be found at operation 422, and stored in the eCommerce deals database 424. These databases 420, 424 may be accessed later by a user interface to present both local store results and eCommerce deals for those products that a user has an intent to purchase, but hasn't purchased yet.

It should be noted that in one example embodiment, the operations in the method 400 are performed partially by the eCommerce system 426 and partially by the local search system 428.

FIG. 5 depicts a method 500, in accordance with an example embodiment, of presenting local and online product results. At operation 502, a user may set a level of aggressiveness for notifications. This may be performed in a number of ways. In one example embodiment, the user may select from preset levels, such as “high,” “medium,” and “low.” In another example embodiment, the user may provide a number on a numeric scale. While in the above embodiments, it may be assumed that a general level of aggressiveness can apply to all notifications, in some embodiments the granularity of the aggressiveness may be even finer. For example, the user may be able to set a high level of aggressiveness for certain notifications, products, product types, etc. and a lower level of aggressiveness for other notifications, products, product types, etc.

At operation 504, user information may be downloaded. This may include the user's product and intention data from the eCommerce system database 404, and eCommerce deals pertaining to matched products from the eCommerce deals database 424. At operation 506, user movement may be identified. This may be identified in a number of ways. In an example embodiment, a global positioning system (GPS) module in a mobile device may be used to determine user location. At operation 508, it may be determined if the user movement meets certain criteria, Examples of such criteria include location, speed, and duration at a particular location. If location alone is used, for example, then users who may be in transit and merely passing through a location may receive notifications as to products in the vicinity. While this may be fine for some users, in many instances such notifications may be misplaced, and even dangerous (if, for example, the user is driving at the time of the notification). In light of this, parameters such as speed and duration at a particular location may be used to ensure the user is in a certain area for long enough for it to make sense to send notifications about products in the area.

Assuming the movement criteria is met, then at operation 510 the user location may be sent to a local search system. At operation 512, the local search system may check the availability of the user's (matched) products nearby, by checking the physical inventory database 420. At operation 514, it may be determined if any such products are available nearby. If so, then at operation 516 the local search system API may be called to verify availability nearby. At operation 518, it may be determined if a notification for any available matched products would suit the set notification aggressiveness level. If so, then at operation 520 a notification may be sent to the user. Notably, operations 502-510 and 520 may be performed by at a user device, such as by an application running on a mobile device, while operations 512-518 may be performed by a local search system.

On the front end, which may be implemented as a mobile application, the user may first download the application and log in with eCommerce system credentials.

FIG. 6 is a screen capture depicting a method 600, in accordance with an example embodiment, of displaying an alert notification. Here a notification 602 pops up in an interface on a mobile device 604. The notification 602 may include a button for “later” 606 (or alternatively, “cancel”) and a button for “continue” 608. Selecting “continue” 608 may result in the system redirecting the user to a map screen, as will be depicted in FIG. 7.

FIG. 7 is a screen capture depicting a method 700, in accordance with an example embodiment, of displaying a map screen. Here, the location 702 of a store selling the product of interest, along with its price and store information 704, is depicted on a map 706 showing the user's current location 708. Also depicted is a price 710 from the eCommerce system for the same product, and a coupon 712 presented for the product.

If the user selects the coupon 712, then a coupon screen, as depicted in FIG. 8, is provided. FIG. 8 is a screen capture depicting a method 800, in accordance with an example embodiment, of displaying a coupon screen. Here, a number of scannable coupons 802a, 802b, 802c are provided, corresponding to the local merchant presented in FIG. 7.

When getting the available products by location, the system may return the top product (by intent score) that matches the requirements (e.g., in the relevant location radius, with intent equal or greater to the given intent, etc.).

As discussed earlier, the system may attempt to match products in an eCommerce system to products in a local search system. In some embodiments this may be challenging as one of the systems may utilize unstructured data (such as an eCommerce system having auction listings prepared by individual sellers) and one of the systems may utilize structured data (such as a local search system having product listings that have standard information across multiple retailers). In such instances, a mechanism may be provided to map the unstructured data to the structured data.

FIG. 9 is a flow diagram illustrating a method 900, in accordance with an example embodiment, suitable for mapping unstructured documents to structured documents. First, a number of input documents are collected at operation 902. At operation 904, the documents are aligned with one another using a suitable alignment algorithm. At operation 906, the respective similarity between each pair of documents is identified. When the respective similarity between each of the documents is determined, the documents may be broken into clusters about predetermined, or arbitrarily-selected, centroids. Thereafter, desired data elements in each centroid are identified. It should be noted that the aligning in operation 904 may also identify the location of an element in the cluster member that corresponds to a similar element in the centroid such that, when an element in the centroid is identified, the location of a corresponding element in each cluster member is also identified as well.

Once the desired data elements in each centroid have been identified, the corresponding elements of the other members of the cluster are identified at operation 908. Then the data from the matching elements in each member is extracted at operation 910. It should be noted that the clustering obtained by the alignment in operation 904 may be used to determine the location of the corresponding data elements in each of the clusters in operation 908. Nevertheless, operation 910 may be useful from an implementation standpoint. Once the data from the matching elements has been extracted in a predetermined fashion, the data can be used by a suitable content aggregator to provide results to particular queries or in any other suitable fashion.

FIG. 10 is a diagram illustrating a comparison of two documents in accordance with an example embodiment. Table 1010 represents a group of elements within a first member. Table 1020 represents a group of elements within a second member. Table 1030 represents the penalty associated with dissimilarities between member 1 and member 2. Result 1040 shows the tabulation of the total dissimilarity between the two members. Result 1040 may be used to determine whether a first member is sufficiently close to a second member to be considered as part of a cluster having the second member as the centroid.

Furthermore, the comparison between the two documents establishes a correlation between the location of each of the elements in the first group and the location of the corresponding or matching elements in the second group. Thus, the location of each of the elements in the second group is readily obtainable from the location of each of the elements in the first group, or vice versa.

A suitable algorithm may be used to determine the relative similarity between each of the individual pages. This relative similarity helps to form the clusters. In addition, a suitable one of these algorithms may be used to determine whether the cluster member is within a predetermined threshold distance from a centroid, The threshold may be set such that any member of any cluster will be within a particular distance of the centroid and, therefore, will be an appropriate candidate for data extraction based on the data element identification of the centroid.

In the event that the comparison to a centroid is faulty e.g., the elements obtained in the corresponding members do not accurately reflect the marked data elements in the centroid then a new centroid may be chosen. Alternatively to the change of the centroid, automated identification and elimination of outlying cluster members that do not map sufficiently with the cluster centroid, but are still within the threshold, is also possible.

As described above, in one embodiment of the invention, these two steps of aligning about a cluster and determining the corresponding elements in the cluster members may be combined. In such embodiments, a centroid is chosen and then the cluster about the centroid may be filled only with the members that are within the threshold. Then, the data extraction can begin for the members of the cluster without requiring additional aligning. Thereafter, a new centroid can be selected for the members who were not within the distance threshold for the first centroid and a new cluster can be formed.

The following algorithm is an example of one embodiment of a clustering algorithm that may be used in accordance with an example embodiment. Other clustering algorithms may also be suitable for use in systems and methods according to the inventive subject matter.

1. for each document doe do
2. minΔ.=infinite
3. for each centroid c in the clusters
4. Δ=doc compared with c
5. if Δ is less than mint then minΔ=Δ
6. next
7. if minΔ is less than the threshold then
8. add doe to the cluster that produced minΔ
9. else
10. create a new cluster and let doe be its centroid
11. end if
12. next

Line 1 of the algorithm starts iteration through all the input documents. Line 2 initializes a variable that will set the distance to the most similar centroid to infinity. Line 3 starts iteration through all the cluster centroids created so far. In line 4, the document is compared to the first centroid in the iterative process. The comparison can be done by aligning the documents as described in FIG. 10. Line 5 determines whether the presently selected centroid is most similar to the selected document. Line 6 shifts to the next centroid. Line 7-8 shows adding the document to the cluster associated with the nearest centroid. The threshold in line 7 may either be input by an operator or automatically determined. The threshold may be set to limit the cluster to documents having data that, when extracted, are sufficiently similar to the data of the centroid. Such a selection of the threshold will generally produce useful data. Lines 9-10 show the creation of a new cluster.

In an example embodiment, the user intent information compiled by the various processes described above may be enriched by using a clustering or similar algorithm for mapping unstructured data to structured data. For example, a user may view multiple different auction listings for mobile phones. Instances where the user has viewed multiple auction listings for the same type of mobile phone (e.g., same model number, but sold by different individuals) may be aggregated. This allows the system to rank the intent to purchase of particular products, not just particular listings.

In another example embodiment, the user in ent information may be further enriched by assigning different weights to different types of user actions, For example, placing a bid on an item may be weighted very strongly as an intent to purchase the corresponding product, whereas merely viewing the item or adding it to a watch list may be weighted less strongly, In some example embodiments, a machine learning algorithm may be applied to the weights to dynamically adjust the weights based on learned behavior, either over multiple users or behavior specific to one particular user. For example, the system may learn over time that one particular user likes to view or watchlist items that he or she never winds up buying, and thus may weight such actions more weakly than the same actions performed by someone who almost always winds up buying items that were viewed or watchlisted.

FIG. 11 is a flow diagram illustrating a method 1100, in accordance with an example embodiment, of displaying product information to a user. At operation 1102, information about user actions with respect to a product on the eCommerce system is retrieved. At operation 1104, a user intent to purchase the product is determined based on the information about user actions. At operation 1106, the product is matched to a product on a local search service. At operation 1108, a local search on the matched product is performed on the local service, to locate one or more stores local to a user's current location that have the matched product in stock. At operation 1110, results from the local search are displayed to a user.

FIG. 12 is a block diagram of a machine in the form of a computer system within which a set of instructions 1224 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In one embodiment, the machine will be a server computer; however, in alternative embodiments, the machine may be a personal computer (PC), a tablet PC, a set-top box (STB), a Personal Digital Assistant (PDA), mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210, an alphanumeric input device 1212 (e.g., a keyboard), and a user interface (UI) navigation (e.g., cursor control) device 1214 (e.g., a mouse). In one embodiment, the display unit 1210, input device 1212 and cursor control device 1214 are a touch screen display. The computer system 1200 may additionally include a storage device (e.g., drive unit) 1216, a signal generation device 1218 (e.g., a speaker), a network interface device 1220, and one or more sensors (not pictured) such as a global positioning system sensor, compass, accelerometer, or other sensor.

The drive unit 1216 includes a computer-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the computer-readable medium 1222 is illustrated in an example embodiment to be a single medium, the term “machine-readable medium” may include a single medium or multiple media (e.g., a centralized or distributed database, and/or associated caches and servers) that store the one or more instructions 1224. The term “machine-readable medium” shall also be taken to include any tangible medium that is capable of storing, encoding or carrying instructions for execution by the machine and that cause the machine to perform any one or more of the methodologies of the embodiments of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVDROM disks.

The instructions 1224 may further be transmitted or received over a communications network 1226 using a transmission medium via the network interface device 1220 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. An apparatus comprising:
a processor;
a memory;
a geolocation module configured to determine a current location of a user;
a user intent module configured to:
retrieve, from an eCommerce system, information about user actions with respect to a product on the eCommerce system; and
determine a user intent to purchase the product base on the information about the user actions;
a local search interface configured to:
match the product to a product on a local search service;
perform a local search on the matched product on the local search service, to locate one or more stores local to the user's current location that has the matched product in stock; and
a display module configured to display results from the local search.

2. The apparatus of claim 1, further comprising a user movement module configured to determine movement by a user and determine if the user movement matches preset movement criteria, wherein the performing a local search is initiated upon a determination that the user movement matches preset movement criteria.

3. The apparatus of claim 1, wherein the display module is configured to determine whether the results of the local search match an aggressiveness level for the user and to display results from the local search only in response to a determination that the results of the local search match an aggressiveness level for the user.

4. The apparatus of claim 1, further comprising an eCommerce system interface configured to retrieve a price for the matched product from an eCommerce system database, and wherein the display module is further configured to display the price for the matched product simultaneously with the results from the local search.

5. The apparatus of claim 1, wherein the user actions include unsuccessful bids placed in online auctions.

6. The apparatus of claim 1, wherein the user actions include identifying products to watch on the eCommerce system.

7. The apparatus of claim 1, wherein the user actions include viewing product pages on the eCommerce system.

8. The apparatus of claim 1, wherein the user actions include conducting searches on the eCommerce system.

9. The apparatus of claim 1, wherein the determining of a user intent includes weighting user actions based on type.

10. A method comprising:
retrieving, from an eCommerce system, information about user actions with respect to a product on the eCommerce system;
determining a user intent to purchase the product based on the information about user actions;
matching the product to a product on a local search service;
performing a local search on the matched product on the local search service, to locate one or more stores local to a user's current location that have the matched product in stock; and
displaying results from the local search to a user.

11. The method of claim 10, further comprising:
determining types of one or more user actions based on the information about user actions;
weighting the user actions based on type; and
wherein the determining the user intent is based on the weighted user actions.

12. The method of claim 11, wherein the matching the product to a product on a local search service includes mapping unstructured data from the eCommerce system to structured data from the local search service.

13. The method of claim 10, further comprising monitoring changes in the user's current location.

14. The method of claim 13, further comprising comparing changes in the user's current location to one or more movement rules.

15. The method of claim 14, wherein the performing the local search is initiated in response to a determination that the changes in the user's current location meet one or more movement rules.

16. The method of claim 15, wherein at least one of the one or more movement rules include the user's current location remaining static for a predetermined amount of time.

17. The method of claim 15, wherein at least one of the one or more movement rules includes a speed of the user remaining below a predetermined speed.

18. The method of claim 10, further comprising:
determining a price of the matched product on the eCommerce system; and
displaying the price for the matched product simultaneously with the results from the local search.

19. A non-transitory computer-readable storage medium comprising instructions that, when executed by at least one processor of a machine, cause the machine to perform operations comprising:
retrieving, from an eCommerce system, information about user actions with respect to a product on the eCommerce system;
determining a user intent to purchase the product based on the information about user actions;
matching the product to a product on a local search service;
performing a local search on the matched product on the local search service, to locate one or more stores local to a user's current location that have the matched product in stock; and
displaying results from the local search to a user.

20. The non-transitory computer-readable storage medium of claim 19, wherein the operations further comprise:
determining a price of the matched product on the eCommerce system; and
displaying the price for the matched product simultaneously with the results from the local search.
